(19) United States
(12) Patent Application Publication
(10) Pub. No.: US 2015/0006252 A1
(43) Pub. Date: Jan. 1, 2015

(54) CHAIN OF POLLS

(71) Applicant: 1World Online, Inc., San Jose, CA (US)

(72) Inventors: Alexei FEDOSSEEV, San Jose, CA (US); Bradley KAYTON, Hollis, NH (US)

(21) Appl. No.: 14/318,917

(22) Filed: Jun. 30, 2014

Related U.S. Application Data
(60) Provisional application No. 61/841,022, filed on Jun. 28, 2013.

(51) Int. Cl. G06Q 30/02

(52) U.S. Cl. CPC G06Q 30/0203
USPC 705/7.32

(57) ABSTRACT

Multiple questions are selected into a chain of polls. Questions from the chain of polls are served to each identified user via multiple different online venues. Over time, the results of the cumulative responses of particular users that have answered most or all of the questions in the chain are aggregated and correlated to determine overall user response. This method collects data on many questions while avoiding respondent fatigue by serving the questions in small numbers over time.

### CROSS-REFERENCE TO RELATED APPLICATIONS

This application claims priority to U.S. Provisional Application No. 61/841,022, filed Jun. 28, 2013, which is incorporated by reference as though fully included herein.

### TECHNICAL FIELD

This application relates generally to online polling, and more specifically to providing related polling questions to a particular user over multiple sessions.

### BACKGROUND OF THE INVENTION

Within Internet and online venues and digital properties, what are known to many as Web 2.0 and Big Data services, we are now transitioning to a new level of understanding that information built and shared via social and professional networks needs to be more credible and representative in order to be useful. In particular, there is unmet demand to obtain accurate, quantifiable and comprehensive data on what people really think about various topics in their life and issues in their world. As an example, to optimally plan development and sales for any product or service it is imperative for merchandisers and marketers to best understand customers' views on product features, service appeal, trends, pricing, as well as have reliable, measurable insight into consumer interests and their decision-making processes. The same is true for analysts in every other area of human life, including politics, culture, sports, entertainment, estimates of geographical, educational and vocational trends, etc.

A variety of techniques are used to collect such information by polling consumers, including the use of online surveys. One problem that can negatively impact such data-gathering is known as “respondent fatigue”—the more questions you present to a user in a given setting, the lower your rate and accuracy of response, especially towards the end of a survey. For serialized polls, where the answer of the same consumer to a set of related questions is desired, this can make it difficult to acquire a substantial response.

### SUMMARY OF THE INVENTION

A method and system to is presented create and conduct surveys that are comprised of a “chain of polls” united either by a set of rules or by a set of business requirements and decisions and are presented to the target audience in a new way that is distributed over time and across multiple polling venues.

In one embodiment, the techniques may be realized as a method comprising the steps of grouping a plurality of questions together as a chain of polls; identifying a first communications session with a particular audience member; selecting and serving a first question from the chain of polls to the particular audience member during the first communications session, wherein selecting the first question involves determining that the user has not yet responded to the first question; receiving first data based on the user's response to the first question; identifying a second communication session with the particular audience member, wherein the second session occurs through a different communication channel from the first session; selecting and serving a second question of the chain of polls to the particular audience member during the second session, wherein selecting the second question involves determining that the user has not yet responded to the second question; and receiving second data based on the user's response to the second question.

In accordance with other aspects of this embodiment, one of the first and second communication sessions may include the use of a mobile device application.

In accordance with other aspects of this embodiment, one of the first and second communication sessions may include the use of a web browser.

In accordance with other aspects of this embodiment, the first and second communication sessions may each be internet sessions using a web browser. The first communication channel may be a first website and the second communication channel may be a second website.

In accordance with other aspects of this embodiment, the method may include analyzing the first and second data, including correlating the first data with the second data.

In accordance with further aspects of this embodiment, analyzing the first and second data may include aggregating the first and second data with data based on the responses of other users to the first and second questions of the chain of polls.

In accordance with other aspects of this embodiment, aggregating the first and second data with data based on the responses of other users may further include identifying users that gave similar responses to the first and the second question.

In accordance with another embodiment, the techniques may be realized as an article of manufacture including at least one processor readable storage medium and instructions stored on the at least one medium. The instructions may be configured to be readable from the at least one medium by at least one processor and thereby cause the at least one processor to operate so as to carry out any and all of the steps in the above-described method.

In accordance with another embodiment, the techniques may be realized as a system comprising one or more processors communicatively coupled to a network; wherein the one or more processors are configured to carry out any and all of the steps described with respect to any of the above embodiments.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

Better understanding of the present invention may be obtained by reference to the accompanying drawings, when considered in conjunction with the subsequent, detailed description.

FIG. 1 is a block diagram illustrating the distribution of polling questions into chains of polls in accordance with embodiments of the present invention.

FIG. 2 is a block diagram illustrating the deployment of polling questions from a chain of polls in accordance with embodiments of the present invention.

FIG. 3 is an illustration of a dashboard screen showing the selection of polling questions to create a chain of polls in accordance with embodiments of the present invention.

FIG. 4A is an illustration representing a web-based survey in accordance with embodiments of the present invention.

FIG. 4B is an illustration representing a mobile application in accordance with embodiments of the present invention.

FIG. 4C is an illustration representing a poll question deployed on a widget in accordance with embodiments of the present invention.

FIG. 4D is an illustration representing a poll question asked by means of social network service in accordance with embodiments of the present invention.

FIG. 5 is an illustration of a result display from a chain of polls in accordance with embodiments of the present invention.

FIG. 6 is a flowchart illustrating a method for assembling and deploying a chain of polls in accordance with embodiments of the present invention.

### DETAILED DESCRIPTION

The present invention provides a method and system to create and conduct surveys that are comprised of a “chain of polls” united either by a set of rules or by a set of business requirements and decisions and are presented to the target audience in a way that is distributed over time and across multiple polling venues.

This invention solves the problem of conducting surveys with potentially prohibitive number of questions, solving a surveying research issue known as “respondent fatigue.” This goal is accomplished by distributing survey questions over time and across online polling venues (web sites, mobile applications, etc.). Since the questions are spread out and only a comparatively small number of questions are asked during any particular polling session, respondent fatigue is greatly reduced.

The chain of polls also addresses two other problems related to surveys. One problem is question order effects, whereby responses to certain questions on a survey are influenced by questions asked earlier in the survey, as respondents attempt to discern the purpose of the survey and present themselves in the most desirable way. By asking questions days or even weeks apart, question order effects are eliminated. The second problem is that traditional surveys allow collection of cross-sectional data, which do not allow observation of changes over time. By asking the same question at two or more points in time, researchers can identify changes in attitudes or behaviors, relating these to demographic, psychographic, or other variables, or to events occurring during the intervening time.

Generally, a survey is a collection of individual questions or polls united by a common purpose, which may be a common topic or a set of rules that define an algorithm that selects individual questions from a pool of available questions. In addition, a set of business requirements and decisions regarding the goals of a specific survey could be used to precisely identify individual questions that comprise the pool of available questions for a particular chain of polls.

The pool of available questions combined with the algorithm and the business requirements forms a “chain of polls.” The chain of polls contains all of the questions which will be submitted and the responses tabulated for that particular chain. Any individual question may participate in one or more chains of polls.

When the chain of polls is published, these questions are presented to the members of the target audience. However, instead of presenting all of the potentially very long list of questions, questions are presented to the audience members in small groups, one poll at a time, such as one poll per day over a one month (or longer) period. Questions from a chain are not necessarily advertised as parts of the chain or, in fact, parts of a survey.

Every time a member of the target audience visits a polling venue, one or more questions are selected from the chain of polls, according to the algorithm associated with the chain and the available space for questions associated with the polling venue, and are presented to the audience member. If the audience member spends some time at a polling venue then more questions from the chain may be presented to this member. If a member of the target audience visits multiple polling venues, than the questions from the chain are distributed across these venues, and if the member spends some time at a particular venue or visits the same venue many times, than questions from the chain may be distributed in time. In this way, even though different audience members will have different behaviors and usage patterns, as many of the audience members are exposed to as many of the questions in the chain as possible.

The length of time over which a chain of polls may be deployed for a particular user may differ according to the nature of the topic and the goals of the survey. In some implementations, the overall time period from the presentation of the first poll question in a chain of polls to the last may normally be no more than six months or so, certainly less than a year, to assure that results for different questions can be realistically correlated as reflecting answers of a single respondent disposition.

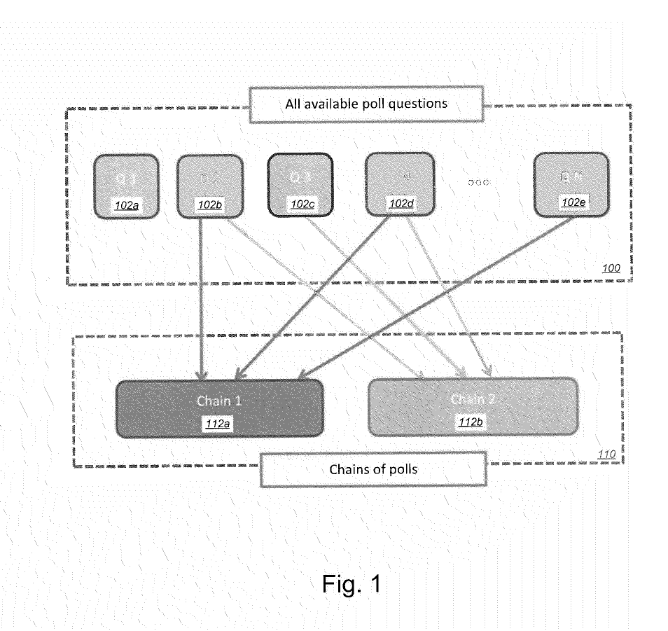

FIG. 1 shows a block diagram which includes a data structure 100 including poll questions 102a-n. The data structure 100 may include all of the data associated with each question 102 that is a part of any of a particular user's surveys, and may include data pertaining to when each question has been deployed and what responses it has received.

A data structure 110 may include each of the chains of polls associated with the particular user account, including chains of polls 112a and 112b. As shown, each of the chains of polls 112 may include any of the poll questions 102. Particular questions may be included in any number of chains of polls, or none of them. As shown in FIG. 1, question 102a is not currently associated with either of the chains 112a or 112b. Questions 112b, 112d, and 112e are associated with chain of polls 112a while questions 112b, 112c, and 112d are associated with chain of polls 112b.

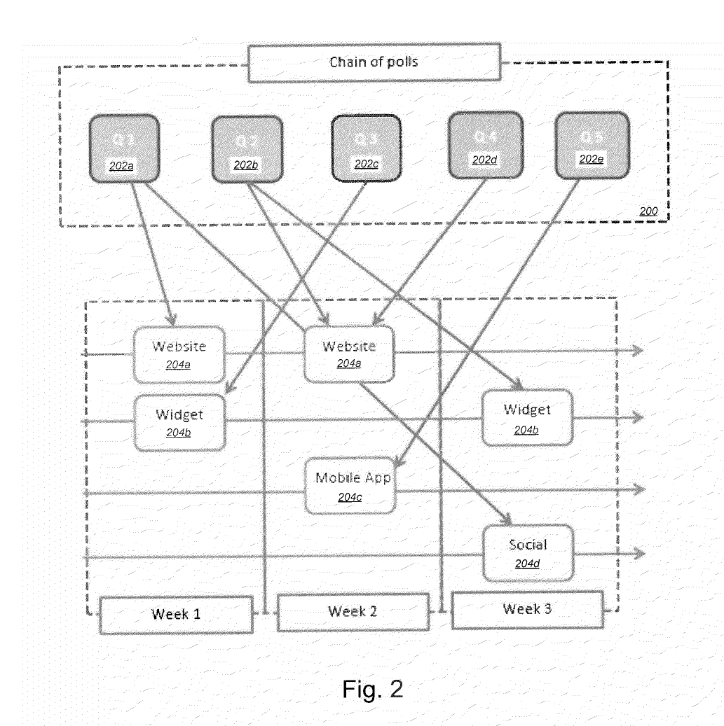

FIG. 2 shows a particular chain of polls 200 including questions 202a-e, and illustrates how that poll might be deployed over time.

As shown in FIG. 2, questions 202 within a chain of polls 200 may be deployed to a variety of different polling venues. Polling venues may include survey websites, mobile devices, widgets hosted by third-party websites, and alternative communication channels such as SMS messaging. Any communication channel that is available to the polling system and can be identified with a particular user can be used to deploy one or more questions to that user.

As shown, during Week 1, question 202a is deployed to a website 204a. Question 202c is deployed to a widget 202b. In Week 2, questions 202b and 202d are deployed to the website 204a, and question 202e is deployed to an application 204c on the user's mobile device. In Week 3, question 202b is deployed to the widget 204b, and question 202a is deployed for a second time by means of a social networking service 204d. Over the three weeks of the deployment of the chain 200, each question 202 is deployed to the particular user at least once.

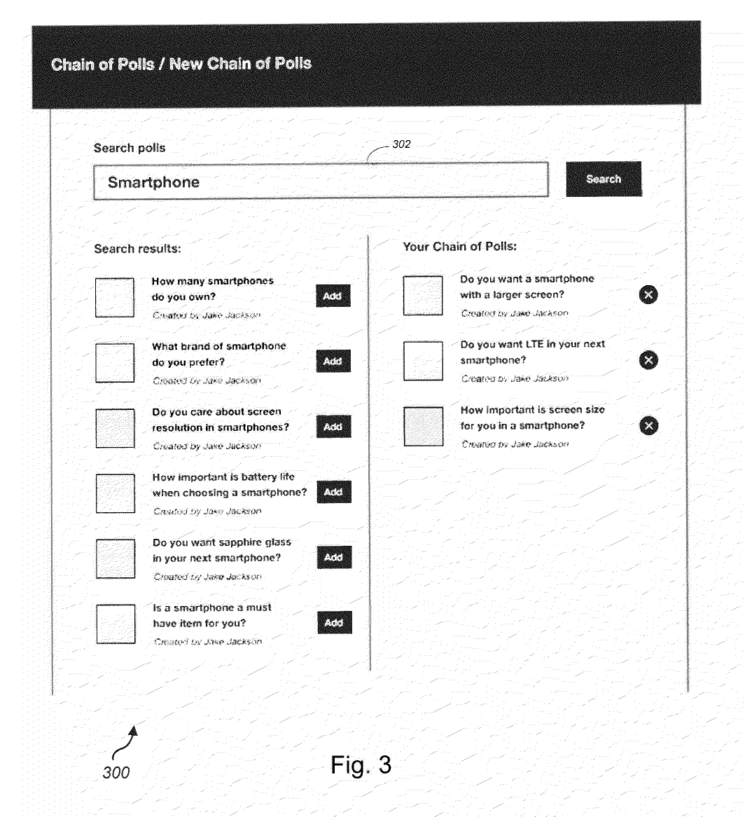

FIG. 3 shows an example of a user interface by which a “survey manager” may create a chain of polls by selecting from available polling questions to add to the chain. In some implementations, a search box 302 may be provided so that a manager can find questions relevant to a particular issue or subject.

As shown, potential polling questions (which may be limited to search results or other means) are shown in the left-hand column 304, while the list of questions selected for the chain of polls is shown in the right-hand column 306. The manager can add and remove questions from the chain of polls. In some implementations, once the manager has selected a list of questions for the new chain of polls, further options may be provided. For example, when the poll should run and which polling venues to use may be customizable in some implementations. In some implementations, the manager may be able to select a targeted demographic or otherwise limit which users will be presented with the polling questions. In some implementations, the answers to certain questions may cause the system to discontinue particular users from further questions (such as if a user has no interest in a particular product or has never used a particular service that is the focus of the chain).

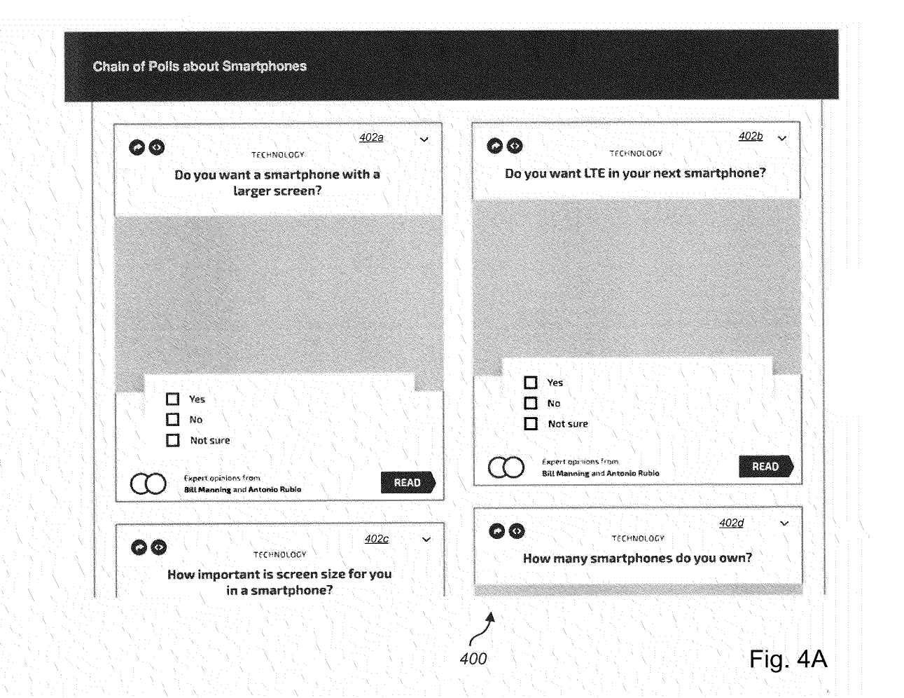

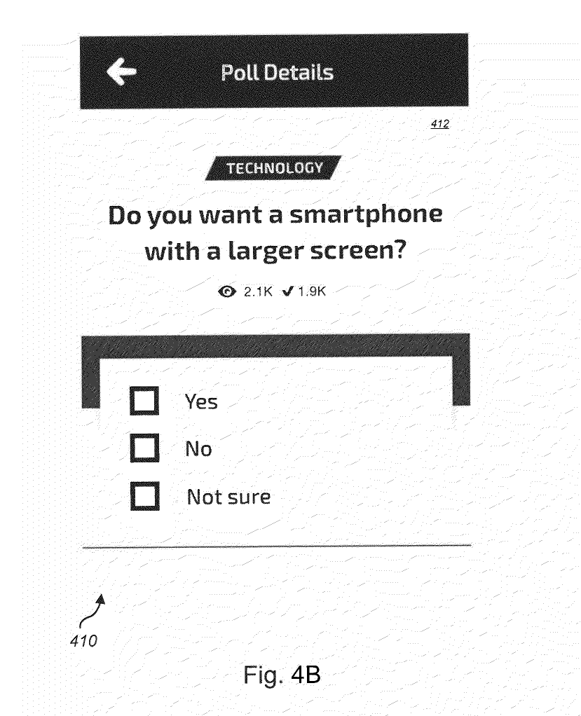

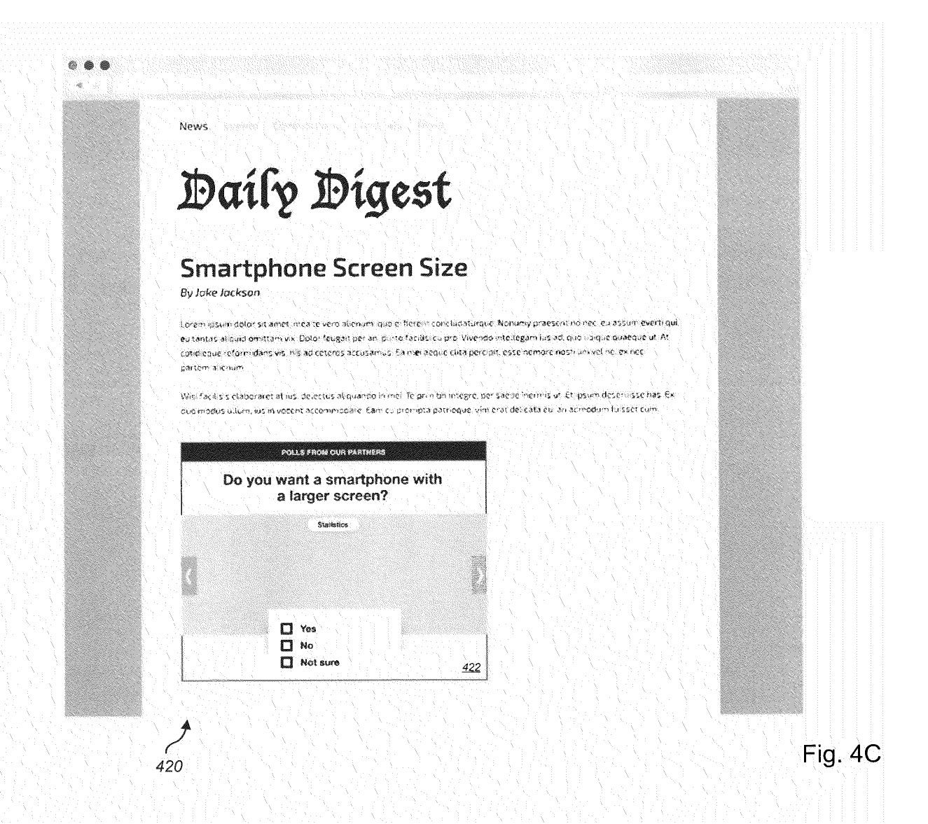

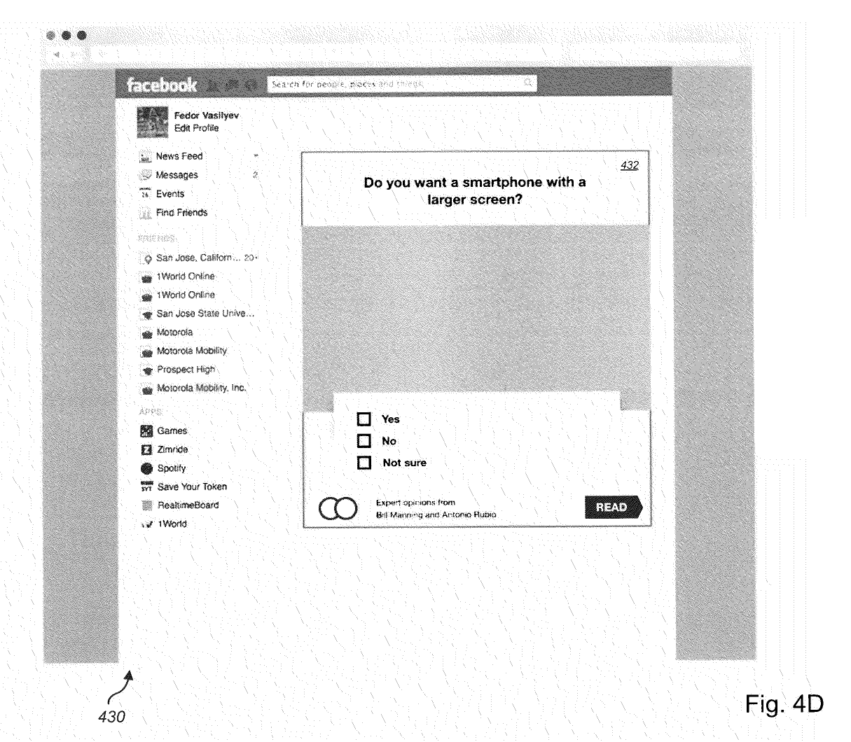

FIG. 4A shows an example of a screenshot of a website 400 which includes questions 402a-d deployed from a chain of polls. In some implementations, the website 400 may include a number of questions from a chain of polls, but in light of “respondent fatigue,” may only register as presented those questions that the user responds to. That is, as the system maintains a record of which questions have been served to the user, when a web page includes multiple questions, any questions that are not answered will be served to the user again as though they had not previously been served to the user.

FIG. 4B shows an example of a screenshot of a mobile device application 410 which includes a question 412 deployed from a chain of polls. The mobile application 410 may include occasional poll questions as part of delivering other content to a user. The mobile application 410 may also be dedicated to poll content but may be connected with other services (such that, for instance, the mobile application 410 is triggered to deploy a poll at intervals based on the user's use of other services). One of ordinary skill will recognize that an application 410 may be deployed on any sort of mobile device.

FIG. 4C shows an example of a screenshot of a third-party website 420 with a widget 422 configured for displaying poll questions, the widget 422 currently displaying a question deployed from a chain of polls. In some implementations, the certain elements of the poll question may or may not display depending on display settings associated with the widget 422. Poll questions may be deployed to the widget 422 based on the content of the site; for example, a question about smartphone screen size may be more likely to be served on a page about smartphone screens.

FIG. 4D shows an example of a screenshot of a social network website 430, the interface displaying a question 432 deployed through the social network service from a chain of polls. Questions may be served based on contextual information relevant to the social network, as well as according to the user's preferences.

Although FIGS. 4A-4D demonstrate different virtual venues in which questions from the chain of polls may be deployed, it will be understood that other communication channels may also be used. Diversifying the means by which poll questions are given to the user provides more opportunities for the user to answer even a small number of questions in each venue, thus adding up to a full set of serialized poll questions over time.

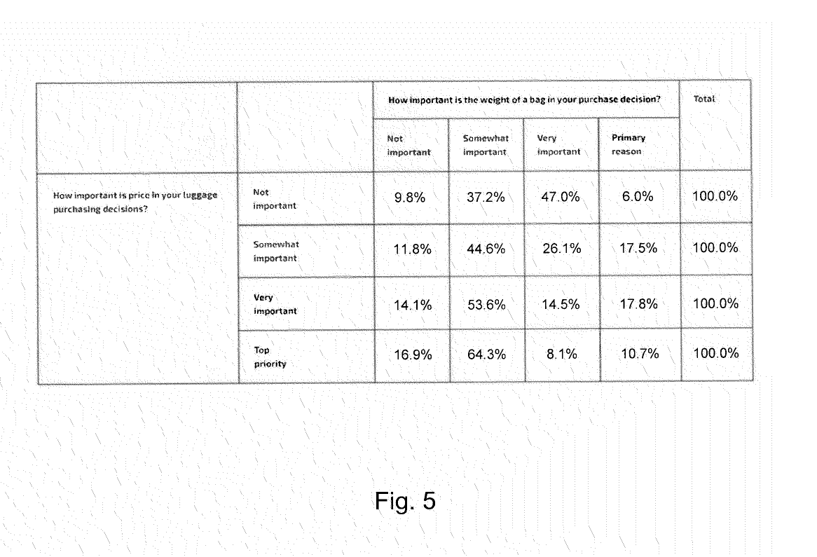

FIG. 5 is an illustration of a particular analysis that may be served as part of the results of a chain of polls. Here, the percentage of users surveyed who selected each response for a first question and each response for a second question is given—showing, for example, that among users who responded that price was a top priority in their luggage purchasing decisions, 8.1% considered the weight very important, while among those for whom price was not important, 47.0% considered the weight very important. These cross-correlations are often difficult to establish through traditional polling techniques because of respondent fatigue, but methods according to the disclosure herein allow for establishment of these correlations, as many questions can be deployed to the same set of users over time.

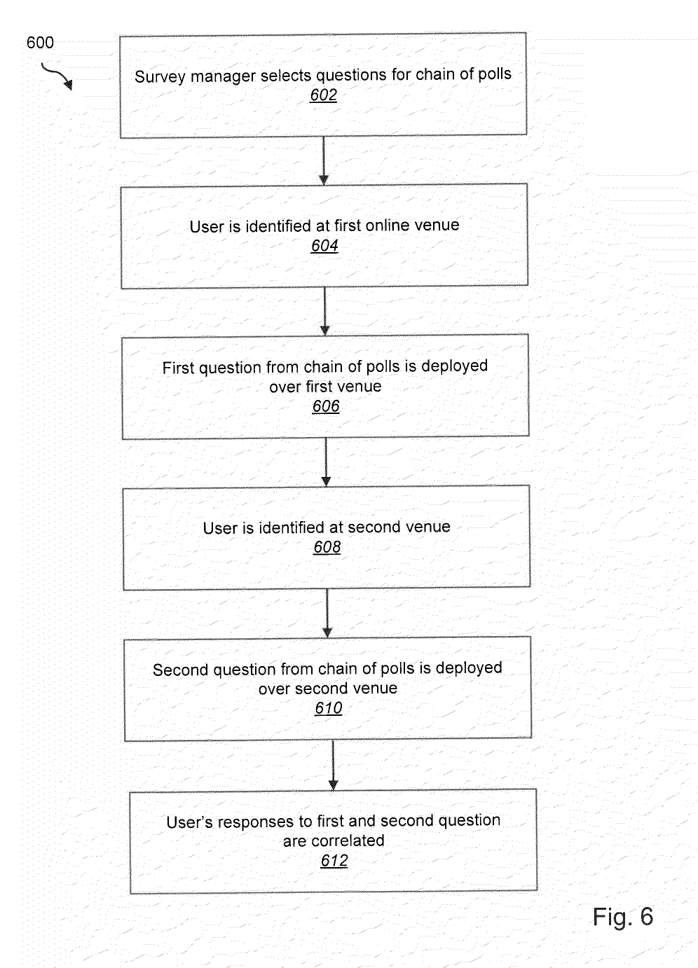

FIG. 6. is a flowchart representing a method 600 for delivering polling questions across multiple venues. The steps of the method 600 are exemplary and represent only some implementations of the invention as described herein.

As illustrated and described above with respect to FIG. 3, a survey managers selects questions for a chain of polls (602). In some embodiments, the chain of polls may be automatically generated by a system capable of recognizing related questions. In addition to selecting the questions, a manager may also choose a time period over which the chain of polls will be deployed and parameters for deployment (how often questions may be served to a given user, demographic limitations on users to be targeted, what sorts of venues to deploy questions, etc.). Any or all of these parameters may also be automatically determined or default values may be used.

A user that is to be targeted with the chain of polls is identified as a first online venue (604). The identification may be, for example, a request by a user's device or browser window to load a particular page. In some implementations, identifying a user may include the user providing authentication credentials to an application or website.

A first question from the chain of polls is deployed over the first venue (606). This may involve supplying the question as part of a page load for a requested webpage. In some implementations, the system tracks which questions the user as previously responded to and selections a first question for which a response is needed from the user. In some questions, responses over time may be compared and a question that the user has responded to before may be nonetheless deployed again.

Subsequently, when the user is identified at a second venue (608), a second question is deployed (610). The second venue may be significantly different from the first, and may involve the user being in a different physical location when accessing the venue. As long as the system is able to identify the user, the system can select questions from the chain of polls for user response.

The user's responses to the first and second questions are correlated (612), such as by the analysis shown in FIG. 5 or similar. By having the same user answer both questions in the chain of polls (and, in some implementations, other questions at other times), the user's responses can be correlated to result in more comprehensive data on user behaviors and attitudes.

The logic to conduct this invention is delivered as software modules. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

At this point it should be noted that techniques in accordance with the present disclosure as described above may involve the processing of input data and the generation of output data to some extent. This input data processing and output data generation may be implemented in hardware or software. For example, specific electronic components may be employed in circuitry for implementing the functions in accordance with the present disclosure as described above. Alternatively, one or more processors operating in accordance with instructions may implement the functions in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

1. A computer-implemented method, comprising:
grouping a plurality of questions together as a chain of polls;
identifying a first communications session with a particular audience member;
selecting and serving a first question from the chain of polls to the particular audience member during the first communications session, wherein selecting the first question involves determining that the user has not yet responded to the first question;
receiving first data based on the user's response to the first question;
identifying a second communication session with the particular audience member, wherein the second session occurs through a different communication channel from the first session;
selecting and serving a second question of the chain of polls to the particular audience member during the second session, wherein selecting the second question involves determining that the user has not yet responded to the second question; and
receiving second data based on the user's response to the second question.

2. The computer-implemented method of claim 1, wherein one of the first and second communication sessions comprises the use of a mobile device application.

3. The computer-implemented method of claim 1, wherein one of the first and second communications sessions comprises the use of a web browser.

4. The computer-implemented method of claim 1,
wherein the first and second communication sessions are each internet sessions using a web browser, and
wherein the first communication channel is a first website and the second communication channel is a second website.

5. The computer-implemented method of claim 1, further comprising:
analyzing the first and second data including correlating the first data with the second data.

6. The computer-implemented method of claim 5, wherein analyzing the first and second data comprises aggregating the first and second data with data based on the responses of other users to the first and second questions of the chain of polls.

7. The computer-implemented method of claim 1, wherein aggregating the first and second data with data based on the responses of other users further comprises identifying users that gave similar responses to the first and the second question.

8. At least one non-transitory processor readable storage medium storing a computer program of instructions configured to be readable by at least one processor for instructing the at least one processor to execute a computer process for performing the method as recited in claim 1.

9. A system comprising:
one or more processors communicatively coupled to a network; wherein the one or more processors are configured to:
group a plurality of questions together as a chain of polls;
identify a first communications session with a particular audience member;
select and serve a first question from the chain of polls to the particular audience member during the first communications session, wherein selecting the first question involves determining that the user has not yet responded to the first question;
receive first data based on the user's response to the first question;
identify a second communication session with the particular audience member, wherein the second session occurs through a different communication channel from the first session;
select and serve a second question of the chain of polls to the particular audience member during the second session, wherein selecting the second question involves determining that the user has not yet responded to the second question; and
receive second data based on the user's response to the second question.

10. The system of claim 9, wherein one of the first and second communication sessions comprises the use of a mobile device application.

11. The system of claim 9, wherein one of the first and second communications sessions comprises the use of a web browser.

12. The system of claim 9,
wherein the first and second communication sessions are each internet sessions using a web browser, and
wherein the first communication channel is a first website and the second communication channel is a second website.

13. The system of claim 9, wherein the processors are further configured to analyze the first and second data, including correlating the first data with the second data.

14. The system of claim 13, wherein analyzing the first and second data comprises aggregating the first and second data with data based on the responses of other users to the first and second questions of the chain of polls.

15. The system of claim 9, wherein aggregating the first and second data with data based on the responses of other users further comprises identifying users that gave similar responses to the first and the second question.
